(19) United States
(12) Patent Application Publication
(10) Pub. No.: US 2010/0058235 A1
(43) Pub. Date: Mar. 4, 2010

(54) METHOD AND SYSTEM FOR NAMING VIRTUAL ROOMS

(75) Inventor: Karl Joseph Borst, Toronto (CA)

Correspondence Address: Pearne & Gordon LLP, 1801 East 9th Street, Suite 1200, Cleveland, OH, 44114-3108, US

(73) Assignee: GANZ, Woodbridge (CA)

(21) Appl. No.: 12/203,234

(22) Filed: Sep. 3, 2008

(51) Int. Cl. G06F 3/048

(52) U.S. Cl. 715/810

(57) ABSTRACT

A method for naming a virtual room provided in a virtual world presentation. The method includes steps of: receiving a user's selection of a first word or phrase from a first list including character names; receiving a user's selection of a second word or phrase from a second list, the second list comprising a plurality of room-type words; and composing a room name by combining the first word or phrase with the second word or phrase.

### BACKGROUND

This application relates generally to a system and method for providing a virtual world presentation for user entertainment including interactive virtual characters, and more specifically to a subsystem and method that allows users to select names for one or more virtual rooms that are provided for the virtual characters, while preventing the selection of rooms names that include undesirable words or phrases.

In recent years, websites and video games in which users care for virtual pets or other characters in a virtual world have become increasingly popular. For example, as described in U.S. Patent Application Publication 2006/0100018 A1 to Ganz, the entire disclosure of which is incorporated by reference herein, a user purchases one or more toys that each include a secret code provided in the toy packaging. When the user carries out a registration process on the manufacturer's website, which involves entering the secret code, a virtual world is presented to the user. The virtual world includes a virtual pet corresponding to each of the toys purchased and registered by the user. The user provides a name for each virtual pet. Each virtual pet may be provided with a virtual room that the user can furnish with virtual furnishings. Optionally, the user can obtain additional virtual rooms in which the user's virtual pets can reside. Additionally the user can invite a second user to visit the user's virtual room(s) and interact the with the user's virtual pets.

In the example system described above, the virtual world presented to the user may include a plurality of different interconnected virtual rooms through which the user can navigate the virtual pets. With this type of virtual world system, it is known to present the user with a map in which each virtual room is provided with a name. The name for each virtual room can be a generic one provided by the system or can be provided by the user to allow for easy identification and navigation between virtual rooms. When the user invites a second user to visit the user's virtual rooms, the second user can also view the map along with the names.

Various offensive-language filtering methods have been used in order to prevent users from providing offensive names for the virtual rooms. For example, one such filtering method is described in co-pending U.S. patent application Ser. No. 12/042,045, filed on Mar. 4, 2008. The system and method described therein uses a combination of white lists and black lists to block offensive words and phrases that might be entered by a user.

### BRIEF SUMMARY

Provided is a method for naming a virtual room provided in a virtual world presentation comprising steps of: registering a plurality of virtual characters to a user account; receiving a plurality of character names corresponding to each of the plurality of virtual characters, each of the plurality of character names having been selected by a user; associating a plurality of virtual rooms with the user account; receiving a user's selection of a first word or phrase from a first list, the first list comprising each of the character names; receiving a user's selection of a second word or phrase from a second list, the second list comprising a plurality of room-type words; composing a room name by combining the first word or phrase with the second word or phrase; associating the room name with one of said virtual rooms, the one of said virtual rooms having been selected by the user; and providing room name data including the room name for display to the user on a computer display.

### BRIEF DESCRIPTION OF THE DRAWINGS

FIG. 1 shows an exemplary user interface illustrating an example virtual room for a virtual character;

FIG. 2 shows a portion of an exemplary user interface illustrating an example map for navigating between a plurality of virtual rooms;

FIG. 3 shows an exemplary user interface illustrating an example menu box for renaming a virtual room; and

FIG. 4 shows an example administrative tool for managing word lists used to generate the menus used for renaming a virtual room.

### DETAILED DESCRIPTION

The subject application relates to a computer-based entertainment system in which a user can be permitted select names for virtual rooms in a virtual world by selecting portions of the name from a series of specially adapted menus or lists.

An example of an entertainment system that is suitable for use herewith is described in U.S. Patent Application Publication 2006/0100018 A1 to Ganz, the entire disclosure of which is incorporated herein by reference. Other suitable entertainment systems may also be used.

Provided is an entertainment system including an online “virtual world”, also referred to herein as a “virtual environment” where the user of a toy, for example, can register the toy using a registration number provided with the toy when purchased or otherwise associated with the toy, adopt the toy online, and play with a virtual representation of the toy (referred to herein as the “virtual character”) in the virtual world. Although the virtual character is described herein as representing a real-world item in the virtual environment and being generated in response to registration of a code associated with the real-world item, it is to be noted that the claimed invention is not so limited. Instead, the claimed invention can be utilized to facilitate communications from any virtual character in any virtual environment to the user via a user computer.

In an illustrative embodiment, mostly as implemented by computer executable instructions read from a computer-readable medium and executed on a programmed computer, e.g a client and/or server over a network. The “virtual environment” can be implemented using an interactive website via a user computer connected to the Internet. In this manner, a user can play with the virtual character in a computer generated fantasy world (i.e., the virtual environment). Examples of the computer-readable medium suitable for storing the computer executable instructions include a magnetic or solid-state hard disk drive (“HDD”) provided to a personal computer, server and the like; an optical storage medium such as a compact disc (“CD”), digital versatile disc (“DVD”) and the like; electronically erasable programmable read-only memory (“EEPROM”) such as a USB flash drive and the like; and any other medium that can store the computer executable instructions in a format that can be retrieved and parsed by the user computer.

Graphics, animation, sound, and even recorded images might be utilized to generate this virtual environment. Even live images might be utilized, if desired. In addition, other sources of material can also be utilized. In essence, the virtual environment creates an interactive playland for the toy owner to encourage imagination using the toy, and at the same time, provide an incentive to purchase additional toys or encourage additional individuals to also purchase toys in order to participate in the entertainment system.

Throughout this disclosure, the term “virtual” is used, for example, to describe the user perceivable, e.g., viewable/hearable material presented to the user on the user computer from data and/or computer programs and commands generated and/or provided by the entertainment system, to the user computer running one or more computer applications (e.g., a web browser with the appropriate plug-ins, applets, and/or other support programs, etc.). The entertainment system can provide the data and/or programs, via a communication network connected to the entertainment system and the user computer (e.g., the Internet). According to alternate embodiments, the data and/or programs, or at least a portion thereof, can be stored locally by the user computer and parsed or otherwise executed to present the virtual environment to the user.

The term “virtual” does not necessarily mean that the displayed item is not a “real” image or video, because the displayed item could, for example, be a video or picture of a real-world item, for example. Furthermore, the “virtual environment” is presented using “real” physical phenomena (e.g., light and sound), and is impacted by “real” user interactions (e.g., mouse and keyboard manipulations). Rather, the term “virtual” is used to describe the computer generated and/or provided presentation to the user, including both visual and audible effects, via the user computer, rather than existing in the tangible world. It is a “virtual environment” in the sense that it is primarily a computer presented fantasy world with which the user can interact via manipulations of the user computer. In this manner, the “virtual” items of the virtual environment can be presented as interacting with each other and with the user. Furthermore, the user is provided access to games and trivia as well.

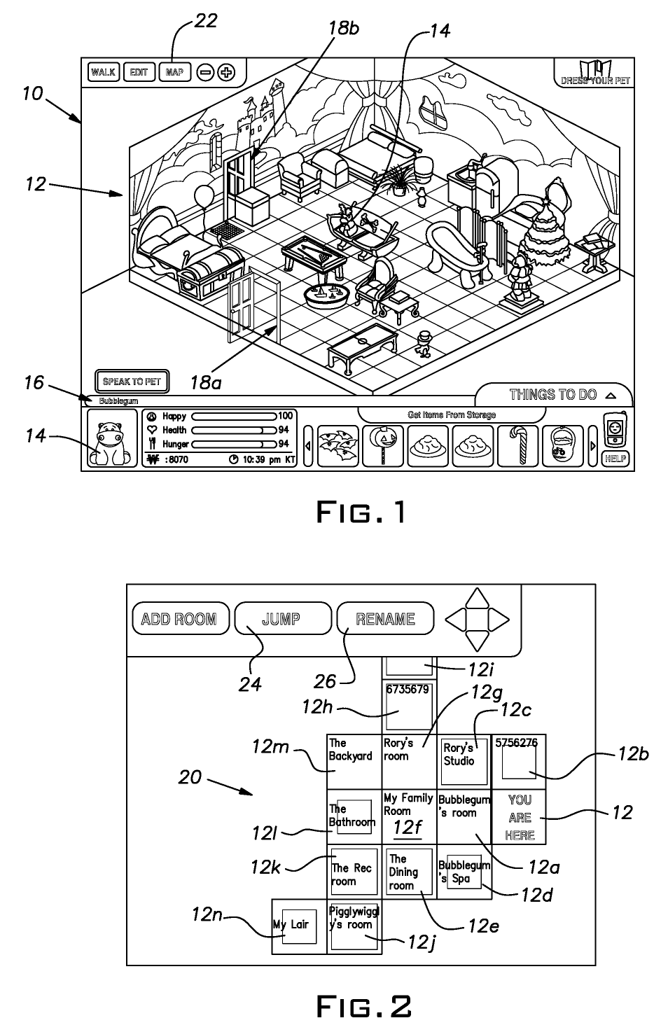

FIG. 1 shows a user interface 10 that is displayed on the screen of a user's computer. The user interface 10 displays various virtual items associated with the user's account, including a virtual room 12 that is provided for a virtual character 14 that can interact with the virtual room 10. As shown, the virtual room 12 can be provided with various virtual items, such as furnishings, with which the virtual character 14 can interact. The virtual character 14 is provided with a character name 16, for example “Bubblegum,” which was chosen by the user when the virtual character 14 was “adopted” or registered to the user's account. A suitable word and phrase filtering subsystem can be employed to help prevent the user from using inappropriate words or phrases in the character name for the virtual character. For example, a black-list based system can be used which prevents the character name from including any words or phrases that are found in a list of banned words and phrases.

The character name 16 is displayed above the virtual character on the user interface 10. Any number of additional virtual characters (not shown), each having a character name, may also be registered to a user's account. Thus, a list of character names is associated with the user's account, for example “Bubblegum”, “Rory”, and “Pigglywiggly.” Any number of additional virtual rooms 12a-12n (FIG. 2) may also be associated with the user's account. For example, an additional virtual room can be provided to the user for each additional virtual character registered by the user. As illustrated in FIG. 1, the virtual room 12 is provided with portals 18a, 18b, depicted as virtual doors, to allow the virtual character to navigate between the virtual room and adjacent virtual rooms 12a, 12b. The user can display a map 20 (FIG. 2) showing all of the virtual rooms associated with the user's account by selecting the “MAP” button 22 on the user interface 10. The entertainment system also permits another user (“guest”) to visit the user's rooms using a virtual character belonging to the guest. A similar user interface is displayed to the guest on the display of the guest's computer. While the guest is visiting the user's room, the guest can also display the map 20 (FIG. 2) by pressing the “MAP” button 22.

FIG. 2 illustrates a portion of the user interface 10 in which the map 20 is currently displayed to the user or the user's guest. As shown, each of the virtual rooms 12, 12a-12n is represented by a room box on the map 20. The room box for the virtual room 12 that is currently active is labeled with the designation “YOU ARE HERE.” Each of the room boxes corresponding to the additional virtual rooms 12a-12n is labeled with a corresponding room name.

When a new virtual room is initially associated with a user's account, it can be automatically named by the system, for example in one of two ways. First, virtual rooms assigned to a particular virtual character can be automatically named. For example, as illustrated in FIG. 2, a virtual room 12a, which is assigned to the virtual character named “Bubblegum” by the user, can be automatically named “Bubblegum's room” by the system. Second, virtual rooms purchased or otherwise obtained by the user that were not provided with a particular virtual character, can automatically be named using a sequentially or randomly generated number or other identifier. For example, the room boxes for virtual rooms 12b and 12h, shown on the map 20 are respectively labeled “5756276” and “5735679”.

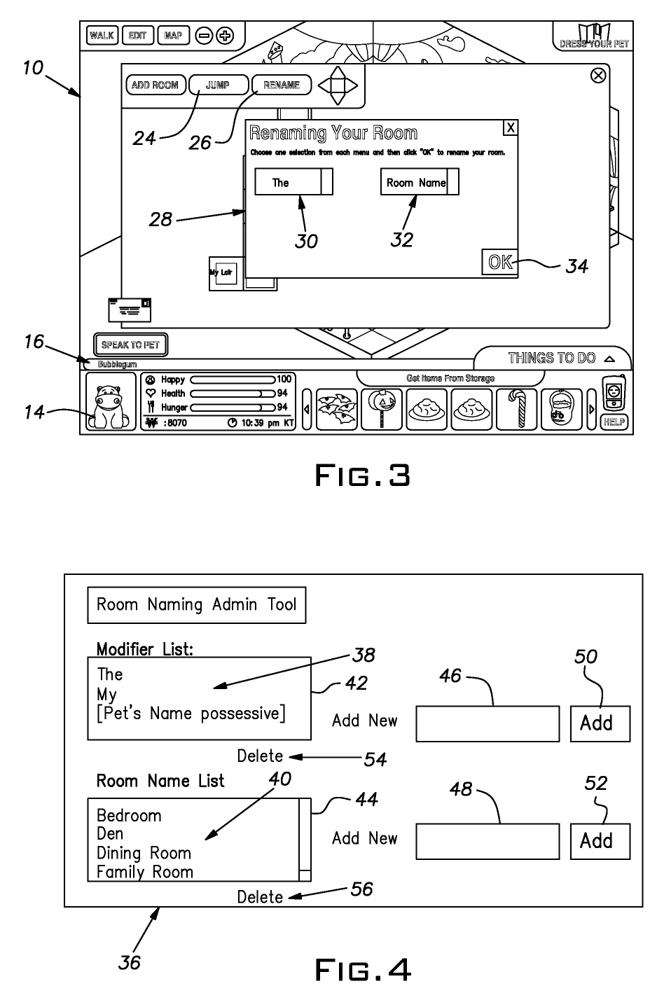

Further, while the map 20 is displayed, the user or guest can click on a room box and the “JUMP” button 24 to navigate directly to the corresponding virtual room. In order to choose a new name for a virtual room, the user may click on the corresponding room box and the “RENAME” button in order to display a renaming box 28 (FIG. 3).

As shown in FIG. 3, the renaming box 28 includes two drop-down style menus 30, 32. The first menu 30, or modifier menu, contains a list of modifiers (“first list”) for forming the first part of the room name. The first list includes words such as “My” and “The,” along with each of the virtual character names associated with the user's account, which have been modified to be in the possessive grammatical form. For example, following the above examples, the following possessive character names would be included in the first list: “Bubblegum's”, “Rory's” and “Pigglywiggly's.” The second menu 32, or room-type menu, contains a list of descriptive room names (“second list”) for forming the second part of the room name. An example second list is shown below in Table 1.

TABLE 1
Example list of words and phrases for use in the second menu:

All purpose room
Backyard
Bathroom
Bedroom
Cave
Classroom
Cove
Den
Dining Room
Gallery
Garage
Garden
Greenhouse
Hall
Hideaway
Kitchen
Lair
Living room
Maze
Movie Room
Mud room
Museum
Nursery
Office
Playroom
Rec room
Restaurant
Salon
Sitting room
Spa
Spare room
Store
Studio
Track
TV Room

In order to select a name for a selected virtual room, the user chooses one modifier or possessive name from the first menu 30 and one room-type from the second menu 32 and then clicks the “OK” button 34. The system then composes the new room name by appending the user's selection from the second menu 32 with the user's selection from the first menu 30. The selected virtual room will be labeled with the new room name on the map 20. For example, the room name “Rory's Studio,” as shown in FIG. 2 as the name of virtual room 12g, was selected by the user by selecting the possessive name “Rory's” on the first menu 30 and selecting the room-type “Studio” on the second menu 32. As another example, the room name “My Lair,” as shown in FIG. 2 as the name of virtual room 12j, was selected by the user by selecting the modifier “My” on the first menu 30 and selecting the room-type “Lair” on the second menu 32.

As described above, the user is limited to composing a room name by combining a modifier or possessive character name with a room name selected from a “preapproved” list. Thus, it becomes possible to prevent the user from choosing a room name that is inappropriate or offensive to others. This is particularly important since other users may be able to see a user's room names when visiting the user's rooms as a guest. Also, by including the possessive character names in the first list, the system allows the user the freedom to create room names that suitably complement game play and satisfy the user. It also allows two word names, while minimizing the possibility that a user could select names with inappropriate connotations. If a user were allowed single words only, the room names may be boring to the user. However, two word names allow the user to concatenate words to create more specific meanings. Even a two word combination can have an astronomical number of possibilities. This system allows only certain words in the combination, thus dramatically reducing the number of possible room names, but still allowing a significant number of possible room names for a user to choose from.

By contrast to the present system, the use of known filtering systems, such as white list-based filters, while capable of preventing a user from using offensive words and phrases, may not permit a user the freedom to appropriately name virtual rooms by including the names of the virtual characters. Furthermore, white list-based systems are generally unable to prevent the use of offensive or inappropriate phrases that are formed by using a series of non-offensive words that are included in the white list.

As shown in FIG. 4, an administrative tool 36 is provided for managing a first list 38 and a second list 40 which can be used to populate the first and second menus 30, 32 described above. The administrative tool 36 can be restricted so that access is provided only an administrator of the entertainment system or other administrative-level users. Using the administrative tool 36, the administrator can add and delete words and phrases from the first and second lists 38, 40 as needed. The first list 38 is displayed in the “Modifier List” box 42 and the second list 40 is displayed in the “Room Name List” box 44. The administrator can see all of the words in a list 38, 40, by scrolling through the list. The words and phrases are arranged alphabetically within each list 38, 40.

The administrator can use the administrative tool 36 to add a new word or phrase to either list 38, 40 by typing the word into the corresponding “Add New” box 46, 48 and clicking the corresponding “Add” button 50,52. Also, the administrator can use the administrative tool 36 to delete a word or phrase from either list by highlighting the word or phrase and clicking the corresponding “Delete” control 54, 56, thereby causing the highlighted word or phrase to be deleted.

As used herein, the terms “system” and “subsystem” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. This system can also be run on a special purpose machine, e.g., a game console or handheld gaming device.

The invention has been described hereinabove using specific examples; however, it will be understood by those skilled in the art that various alternatives may be used and equivalents may be substituted for elements or steps described herein, without deviating from the scope of the invention. Modifications may be provided to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A method for naming a virtual room provided in a virtual world presentation comprising steps of:
registering a plurality of virtual characters to a user account;
receiving a plurality of character names corresponding to each of the plurality of virtual characters, each of the plurality of character names having been selected by a user;
associating a plurality of virtual rooms with the user account;
receiving a user's selection of a first word or phrase from a first list, the first list comprising each of the character names;
receiving a user's selection of a second word or phrase from a second list, the second list comprising a plurality of room-type words which are limited to words that are descriptive of types of rooms;
composing a room name by combining the first word or phrase with the second word or phrase;
associating the room name with one of said virtual rooms, the one of said virtual rooms having been selected by the user; and
providing room name data including the room name for display to the user on a computer display.

2. The method of claim 1, wherein the first list further comprises “my” and “the”.

3. The method of claim 1, wherein each of the character names included in the first list have been automatically modified to be in the possessive grammatical form.

4. The method of claim 1, wherein the room name data comprises map data which permits the display of a map to the user, the map including a representation of each of the plurality of virtual rooms, and the room name being displayed in association with said one of said virtual rooms.

5. The method of claim 1, further comprising the step of providing the room name data for display to another user on another computer display.

6. The method of claim 1, further comprising:
receiving an additional word or phrase via an administration tool that is only accessible to administrative-level users; and
adding the additional word or phrase to the first list or the second list as selected via the administration tool.

7. The method of claim 1, further comprising:
receiving a selection of a word or phrase via an administration tool that is only accessible to administrative-level users; and
deleting the word or phrase from the first list or the second list as selected via the administration tool.

8. A method for naming a virtual room provided in a virtual world presentation comprising steps of:
accepting input from a user who has a user account,
registering a first virtual character to said user account;
receiving a first character name for the first virtual character, and associating the first character name with said first virtual character;
registering a second virtual character to said user account;
receiving a second character name for the first virtual character, and associating the second character name with said second virtual character;
associating a plurality of virtual rooms with the user account;
receiving a user's selection of a first word or phrase from a first list, the first list comprising only forms of each of said first and second character names and possessive words for said first and second virtual characters;
receiving a user's selection of a second word or phrase from a second list, the second list comprising only a plurality of room-type words, where said room-type words have descriptive words to different rooms types;
forming a room name by combining the selection of the first word or phrase with the selection of the second word or phrase;
associating the room name with one of said virtual rooms, the one of said virtual rooms having been selected by the user, said associating causing said room name to be automatically displayed each of a plurality of times when said room is displayed.
